(19) United States
(12) Patent Application Publication
(10) Pub. No.: US 2011/0007167 A1
(43) Pub. Date: Jan. 13, 2011

(54) High-Update Rate Estimation of Attitude and Angular Rates of a Spacecraft

(75) Inventors: Anup B. Katake, College Station, TX (US); Michael G. Jacox, College Station, TX (US); James A. Ochoa, College Station, TX (US); Christian Bruccoleri, College Station, TX (US); John P. Zbranek, College Station, TX (US)

Correspondence Address: BURLESON COOKE L.L.P., 2040 NORTH LOOP 336 WEST, SUITE 123, CONROE, TX, 77304, US

(73) Assignee: STARVISION TECHNOLOGIES INC., College Station, TX (US)

(21) Appl. No.: 12/501,288

(22) Filed: Jul. 10, 2009

(51) Int. Cl. H04N 5/225

(52) U.S. Cl. 348/172; 348/E05.024

(57) ABSTRACT

System and method are provided for estimating attitude and angular rate of a spacecraft with greater accuracy by obtaining star field image data at smaller exposure times and processing the data using algorithms that allow attitude and angular rate to be calculated during the short exposure times.

### BACKGROUND OF INVENTION

1. Field of the Invention

This invention relates to systems and methods for guidance and navigation of spacecraft, and in particular to a system for determining attitude and angular rate of a spacecraft by updating images of star fields at a high rate.

2. Description of Related Art

Spacecraft rely on attitude sensors to determine their orientation. The orientation data enable pointing of solar arrays, antennas or imaging systems. Earth sensors, sun sensors and magnetometers provide a very low-accuracy and low-cost measurement of attitude, but for applications requiring accurate pointing, star trackers are required. Star tracker systems normally update at rates varying from 10 Hz to once every few seconds.

Spacecraft also require data on angular velocities for guidance and navigation. Usually angular velocities are obtained by on-board gyroscopes, such as fiber-optic-gyroscopes (FOG), hemispherical resonator gyroscopes (HRG), or laser-ring-gyroscopes (LRG). Gyroscope sensors consume tens of watts of electrical power and are generally large and heavy.

Angular rates can be estimated from a star tracker by performing a differentiation over a time interval. However, the update rate of available star tracker systems is not sufficient to provide rate knowledge that is accurate to even within a few orders of magnitude of that provided by the traditional gyroscopes. The update rate is primarily dictated by the exposure time required by the star sensor for imaging stars and the processing time required to process the acquired image. To increase the update rate, a shorter exposure time is required. This requires an increase in the size of the optics to a value that leads to heavy penalties on size and weight.

Attitude information can be obtained from angular rate measurements of a gyroscope by integration over a known time period. However, gyroscopes are prone to drift because of random walk noise and bias. To correct for this drift, integrated rates need to be periodically adjusted by obtaining an independent attitude estimate, usually via a star tracker. Thus, it is not possible for a spacecraft, in most cases, to carry only one sensor—gyroscope or star tracker. Carrying both a gyroscope and star tracker onboard results in an increase in mass, volume and power consumption. Additionally, spacecraft carry multiples of these combined units to provide redundancy in the event of a failure. To minimize launch costs and spacecraft requirements, it is desirable to minimize the mass, volume and power requirements. Furthermore, during the spacecraft integration and testing phase, integration of two separate instruments—different in operation principles and interfaces, results in increased complexity of the test procedures and leads to delays in launches.

Yoshikawa et al (U.S. Pat. App. Pub. No. 2002/0117585) discloses apparatus for more rapidly determining the attitude of an artificial satellite from star sensors and star catalogs. Images from the star sensors are collated with a star catalog to output a group of candidates, the attitude candidate of the satellite with respect to each candidate is calculated and the attitude candidate on the basis of star images is updated with time.

U.S. Pat. App. Pub. No. 2005/0071055 discloses method and apparatus for refining a spacecraft state estimate, such as an attitude estimate or an angular velocity estimate. The method computes a plurality of equations using residuals describing the difference between observed and predicted star positions based on inertial measurements.

U.S. Pat. App. Pub. No. 2004/0098177 discloses attitude acquisition methods and systems that reduce the time required to acquire spacecraft attitude estimates. Systems receive, during a time increment, successive frames of star-sensor signals, estimate spacecraft rotation throughout at least a portion of the time increment, and process the star-sensor signals into a set of signals that denote star positions across an expanded field-of-view.

What is needed is a single system that is capable of providing both attitude estimates and increased accuracy of angular velocities.

### BRIEF SUMMARY OF THE INVENTION

Disclosed herein is a sensor system that provides high-accuracy, high-update rate (greater than or equal to 100 Hz) attitude and angular velocity estimates of a spacecraft by acquiring and automatically processing images of stars visible to it. The invention comprises an optical lens assembly to collect light from the stars and focus it on a controllable light amplification device. An image of the star field is then acquired by an image sensor located at the focal plane, which is then read out by interface electronics. On-board algorithms residing on a processor then perform image processing to detect stars, compute line-of-sight vectors, and perform autonomous star identification and attitude estimation using algorithms that are disclosed herein. Advanced filtering algorithms are then executed to estimate the angular rates of the spacecraft. MEMS-based accelerometers may provide degraded angular rate data in the event of the incursion of a bright object in the star sensor field of view. The estimated attitude and angular rates may be output to a spacecraft via a command and data interface. Alternatively, only attitude is estimated, or as another alternative, only centroids of stars are estimated.

In one embodiment, a single enclosure houses the electro-optical assembly, embedded processor, power conditioning circuits and spacecraft interfaces attached to a light shade. In another embodiment, a separate electro-optical assembly housing is attached to a light shade and connected via a flexible signal cable to an enclosure housing the embedded processor and interfaces.

### BRIEF DESCRIPTION OF THE DRAWINGS

FIG. 1 illustrates a satellite or spacecraft.

FIG. 2 illustrates a functional block diagram of the system disclosed herein.

FIG. 3 illustrates a functional block diagram of the electro-optical apparatus.

FIG. 4 illustrates the data flow between the various algorithms of the software.

FIG. 5 illustrates a night sky image obtained from the electro-optical assembly at 10 ms exposure showing star magnitudes.

### DETAILED DESCRIPTION OF THE INVENTION

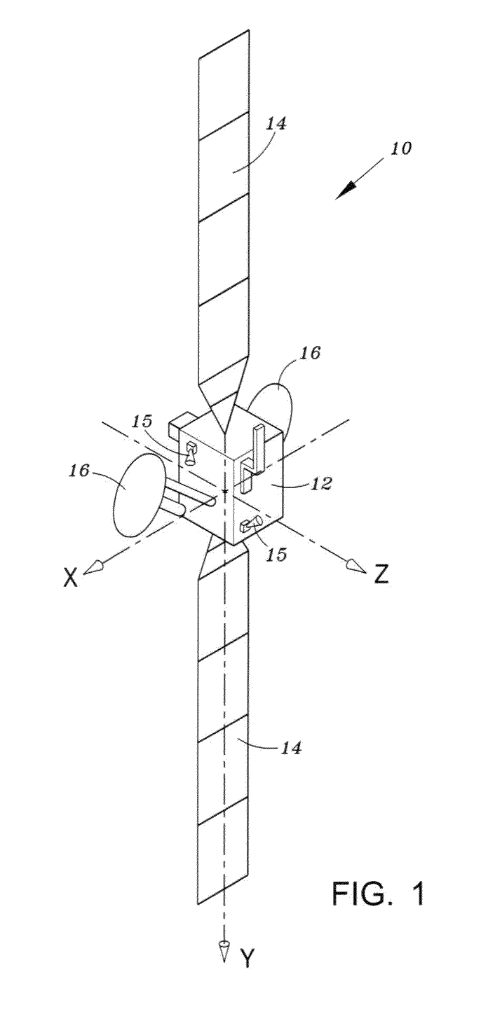

Referring to FIG. 1, a satellite or spacecraft having body 12, solar panels 14 and antennas 16 is illustrated. Light enters the body through star or light sensors 15. The light may be used to measure attitude and angular rates of body 12, according to apparatus and method disclosed herein. The X-axis normally points in the direction of motion and is the roll axis. The Z-axis points in the direction of earth and is the yaw axis.

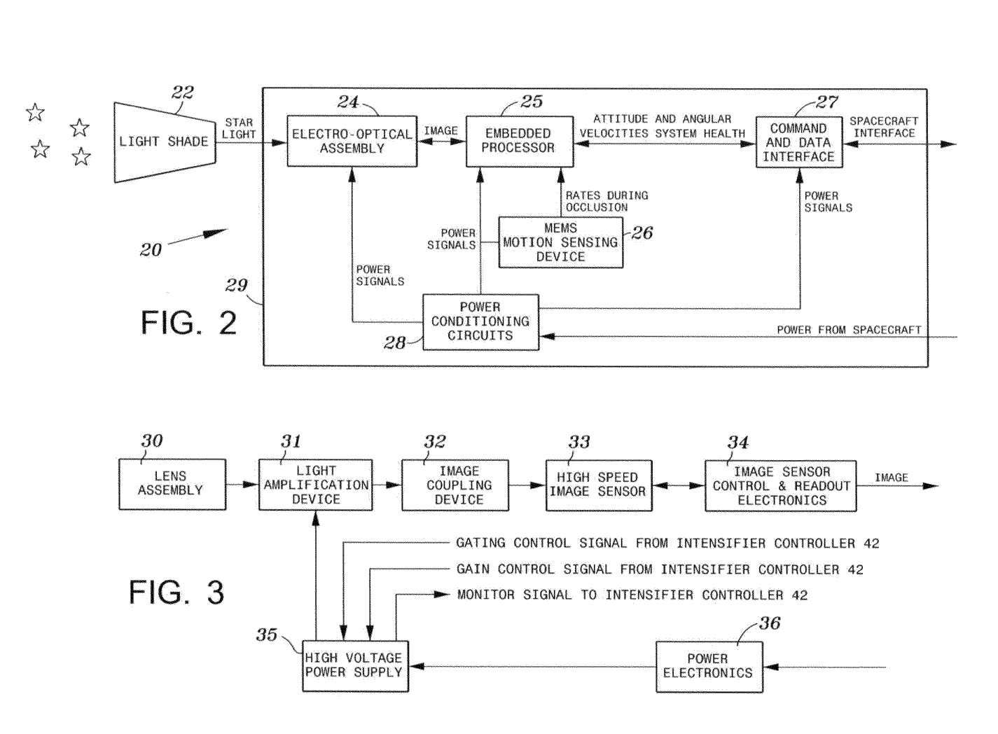

FIG. 2 illustrates a functional block diagram of system 20 disclosed herein. Light enters through light shade 22 into electro-optical assembly 24, which is described in more detail below and in FIG. 3. The signals from assembly 24 enter embedded processor 25, where processing described below occurs. If suitable optical signals are not available, in one embodiment signals from MEMS motion sensing device 26 are processed in processor 25 during occlusion. Results from processor 25 (attitude and angular velocities), consisting of attitude and angular velocities and system health, are sent to command and data interface 27, from which they are sent to a spacecraft interface. The spacecraft may furnish electrical power to power conditioning circuits 28 for use in system 20. Enclosure 29 houses the electro-optical assembly and other components shown in FIG. 2. In an alternative embodiment (not shown), a separate electro-optical assembly housing may be attached to light shade 22, include assembly 24, and be connected by cable to a separate housing for all other components.

Light shade 22 is used to prevent light from bright objects such as the sun, the earth and the moon from entering into the star tracker field of view. The length of light shade 22 is dictated by the requirement of the keep-out-angle as defined by the spacecraft. The length may be mission-specific.

FIG. 3 is a block diagram of electro-optical sub-system 24 of system 20. Lens assembly 30, comprising multiple lens elements, collects parallel light from the stars and focuses it to a point spread function that is determined by the lens distortions. The lenses of lens assembly 30 are optimized to minimize errors associated with the convergence of the light and are designed for a high transmissivity. To avoid blackening of the glass of the lenses from radiation in space, the glass is preferably doped, using materials and methods known in the art.

The primary parameter enabling the high-accuracy performance of the angular rate estimates using star data is the update rate. This directly relates to the rate at which images of the star fields can be acquired from the imaging system. Obtaining images with a sufficient number of stars at a useful signal-to-noise ratio is fully dependant on the light gathering capability of the electro-optical system. In order to obtain high-speed images without the need for extremely large aperture lenses, light amplification device 31 is used. Light amplification device (or image intensifier, II) consists of an input window, photocathode, micro-channel plate (MCP), anode screen and an output window. Other controllable light amplification devices include electron-mulitplying CCDs (EMCCDs). Electron-bombarded CCDs can also be used in place of the image intensifier. Focused light from lens assembly 30 is incident on the input window of amplification device 31. A photocathode located at the back of the input window then converts the incident light photons into photoelectrons. A high voltage power supply, controlled by an intensifier controller, accelerates these electrons towards a MCP (Micro-Channel Plate), which then acts as an electron multiplication channel. The multiplied electrons are then incident upon an anode screen, which then reconverts the photoelectrons back to photons that exit out of the output window. A suitable light amplification device is available from Photonis of The Netherlands or ITT of Roanake, Va. The critical factors determining the performance of the light amplification device are the MCP resolution and the response time of the anode screen. These variables are chosen judiciously to deliver maximum resolution and can be obtained from the manufacturer. The resolution is defined in terms of the modulation transfer function (MTF) and is preferably chosen to be higher than the MTF of the imaging sensor, which is approximately 42 line-pairs/mm in this case. In a fabricated sensor used, which is available as a special order from the vendor, the resolution is 64 line-pairs/mm.

Image coupling device 32, which may be a Fiber Optic Taper (FOT) bundle, comprised of thousands of coherently arranged fibers, is used to couple the output of light amplification device 31 to high speed image sensor 33. The FOT may also contain Extra-Mural Absorption (EMA) configured in an interstitial distribution to prevent cross-talk between adjacent fibers and attenuate divergent light rays. A suitable FOT bundle containing EMA is available from Incom Inc. of Charloton, Mass. A relay lens system, such as the Letus B4 Compact Relay lens made by Letus of Wichita, Kanas. may also be used to transfer the image to the image sensor. A FOT provides a 30% coupling efficiency, as compared with the 5% provided by a relay lens, while being light-weight and compact. A thin layer of refractive index matched ultra-violet curable epoxy, qualified for space environment, may also be applied at the two faces of the FOT so as to rigidly glue the FOT to the output of light amplification device 31 and the die surface of high-speed image sensor 33.

High-speed image sensor 33 may be a 1.3 megapixel (1280×1024 pixel) CMOS image sensor array that is capable of a full-frame readout speed of 500 frames per second. A suitable sensor is available from Micron Inc. of Boise, Id. Other possible sensor embodiments include CCD sensors, back-thinned CCD/CMOS or back-illuminated CCD/CMOS sensors that are capable of high-speed readout. Although the primary criterion for selecting the image sensor is the readout speed, other factors such as quantum efficiency and pixel size are also critical in determining the sensor image quality. The pixel size must be selected and the attachment to the FOT must be performed in such a way so as to couple multiple fibers to each pixel in order to minimize Moiré or chicken-wire distortions.

A rigid enclosure (not shown) may also be present to house each of the lens elements, the image intensifier, FOT and the image sensor. A covering of the appropriate metal and thickness provides for mitigating radiation damage.

Embedded processor unit 25 (FIG. 2) interfaces with electro-optical assembly 24 through sensor control and readout electronics 34 (FIG. 3) to control the operation of assembly 24 to acquire images and execute all the algorithms required to obtain a high-accuracy attitude and angular velocity estimate. Command and data interface 27 may interact with the processor unit of a spacecraft (not shown) to exchange data between the unit and a spacecraft. Using this interface the spacecraft can command system 20 to perform the required actions, can monitor its operation and can obtain sensor estimates. Power conditioning circuits 28, which may be located within an enclosure for system 20, accept power from the spacecraft at the nominal voltage levels and perform all the conversions and reconditioning required to drive electronics. All the above mentioned sub-systems may be housed in rigid enclosure 29 that is designed to provide the required structural, thermal and environmental stability during launch and operations of the sensor system.

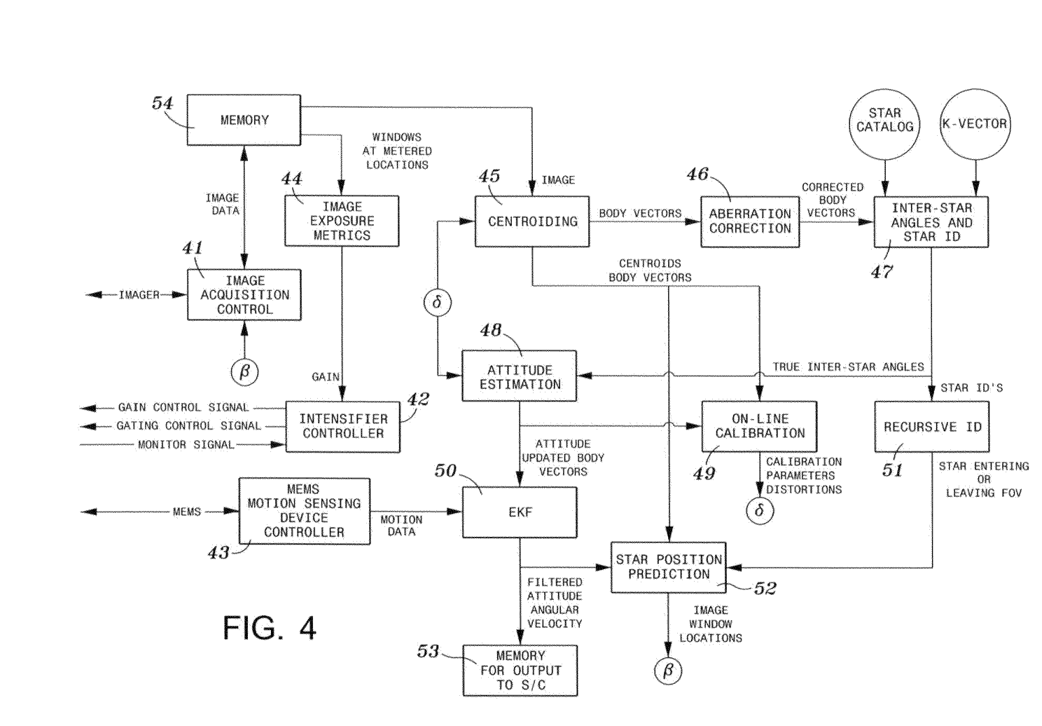

The operation of image sensor 33 (FIG. 3) is controlled by embedded processor 25 (FIG. 2). Given a command for acquiring an image, the processor provides the necessary clock signals, voltages and sequences of signals to read the image from the image sensor. The image can be stored in the memory or directly processed by algorithms described in the following sections. High-voltage power supply 31 receives gating control signals and gain control signals from intensifier controller 42 (FIG. 4). High-voltage power supply 35 may be powered by power electronics 36, receiving power from the spacecraft.

FIG. 4 illustrates the several algorithmic components of the software and the interaction between them. The image acquisition control block 41 interfaces with the processor 25 and, given the settings for the image desired, which may be determined by star position prediction block 52, drives the image sensor and acquires the image. The image may then be stored into on-board volatile memory 54 for off-line analysis or transfer to the ground or it can be directly fed into the centroiding block without storage.

The centroiding block 45, may use methods described in Mortari, D., Bruccoleri, C., La Rosa, S., and Junkins, L. J. “CCD Data Processing Improvements,” International Conference on Dynamics and Control of Systems and Structures in Space 2002, King College, Cambridge, England, Jul. 14-18, 2002, which is hereby incorporated herein, determines the center locations of the star intensity distribution for each star detected in the image using algorithms that will be described in more detail below. The centroiding block 45 also generates line-of-sight vectors to each of the stars given the nominal calibration parameters and feeds them into the aberration correction block 46, star position prediction block 47 and the attitude estimation block 48.

Aberration correction block 46 may modify the line-of-sight vectors using spacecraft location information, a propagated orbit model to account for the aberration in the light direction perceived due to relative motion between the spacecraft, earth and the stars, as described in Paul Marmet (1996), “Stellar Aberration and Einstein's Relativity”. Newton Physics. http://www.newtonphysics.on.ca/aberration/index.html. Retrieved on May 22, 2009, which is hereby incorporated by reference herein. The corrected vectors are then fed into the star identification block 47. The pyramid star identification method, described in Mortari, D., Samaan, M. A., Bruccoleri, C. And Junkins, J. L., “The Pyramid Star Pattern Recognition Algorithm,” Navigation, Vol. 51, No. 3, Fall 2004, pp. 171-183, which is incorporated by reference herein, may be used to robustly identify the imaged stars using an on-board star catalog and a look-up table called the k-vector table, which has designed to provide highly efficient searching. The identified stars and their associated reference vectors from the star catalog are then provided as input to the attitude estimation block 47 and the recursive star identification block 51.

The corrected line-of-sight vectors along with the identified reference vectors are fed into attitude estimation module 48 that computes the attitude of the sensor in an inertial frame of reference. A published method called ESOQ2, described in Mortari, D. “Second Estimator of the Optimal Quaternion,” Journal of Guidance, Control, and Dynamics, Vol. 23, No. 5, September-October 2000, pp. 885-888, which is hereby incorporated by reference herein, is used to estimate the attitude in an efficient manner. Note that other methods such QUEST or TRIADS can be alternately used as well. The choice of the ESOQ2 is solely for the purpose of improving computational efficiency. Any other method based upon the minimization of the Wahba optimality condition will provide an equivalent solution.

The attitude estimate, along with the updated line-of-sight body vectors may then be input to online calibration block 49 and the extended Kalman filter. The online calibration function, as described in Griffith, D. T., Singla, P., Junkins, J. L., “Autonomous On-orbit Calibration Approaches for Star Tracker Cameras,” AAS/AIAA Space Flight Mechanics Meeting, Paper No. AAS 02-102, San Antonio, Tex., Jan. 27-30, 2002, and Griffith, D. T., and Junkins, J. L., “Recursive On-orbit Calibration of Star Sensors,” 2002 World Space Conference, Houston, Tex., October, 2002, both of which are hereby incorporated by reference, estimates the distortions on the imaging system that arise due to the thermal cycling and ageing of the imaging system. Traditional star trackers do not provide for this capability on-board and thus their accuracy performance degrades with time. New sets of calibration parameters are continuously estimated and the on-board parameter set is updated in memory as per command or via automated error tracking and correction. Results are input to centroiding block 45 and attitude estimation block 48.

Extended Kalman Filter (EKF) 50, as described in Singla, P. Crassidis, J. L., and Junkins, J. L., “Spacecraft Angular Rate Estimation Algorithms for a Star Tracker Mission,” Paper No. AAS 03-191, 13th Annual AAS/AIAA Space Flight Mechanics Meeting, Ponce, Puerto Rico, Feb. 9-13, 2003, which is hereby incorporated by reference herein, acts upon the line-of-sight vectors to determine their displacements on the image, and consequently the angular velocities of the spacecraft. The EKF is tuned to noise characteristics expected from the line-of-sight vectors estimation. In the event of a bright object entering into the field of view of the sensor, thereby leading to a loss in image acquisition, on-board MEMS motion data from MEMS motion sensing device controller 43 is fed into the EKF to continuously output angular rates with degraded performance. The EKF is designed to contain the intelligence to detect the change from nominal mode to degraded mode automatically. Output from the EKF goes to memory 53 for output to the spacecraft.

Once the stars have been identified, and given that the spacecraft is operating under nominal orbit conditions, it is not essential to perform a star identification over the entire star data set in the subsequent images. The Recursive ID (also known as predictive centroiding and star identification) block 51 takes in as input the previously identified stars and, using a star neighborhood database and the angular velocities along with block 52 predicts which stars would be entering or leaving the field of view and their position, as described in Samaan, M. A., Mortari, D., Pollock, T. C., and Junkins, J. L., “Predictive Centroiding for Single and Multiple FOVs Star Trackers,” Paper No. AAS 02-103, San Antonio, Tex., Jan. 27-30, 2002, Journal of the Astronautical Sciences, Vol. 50, No. 1, pp. 113-123, January-March 2002, appeared January 2003, which is hereby incorporated by reference. Image window locations are then sent to image acquisition control block 41. Since the locations on the image surface are predicted, only regions of interest around these locations need to be acquired from the image sensor, thereby reducing the time required for readout. This, along with the pre-identification, leads to a drastic increase in the execution speed of the logic, enabling a true 100 Hz attitude and angular rate output when a star image is obtained with an exposure of 10 ms and the calculations described in FIG. 4 can be executed at times of 10 ms or less. The greatly increased update rate allows angular rate to be predicted with much greater accuracy than provided by prior star tracker apparatus and methods. Prior star tracker apparatus can provide full performance attitude estimates only up to a small fraction of angular motion (such as 0.1 deg/s), while the current system can provide full performance attitude estimates (error less than 5 arcsecond) even at 20 deg/s angular motion.

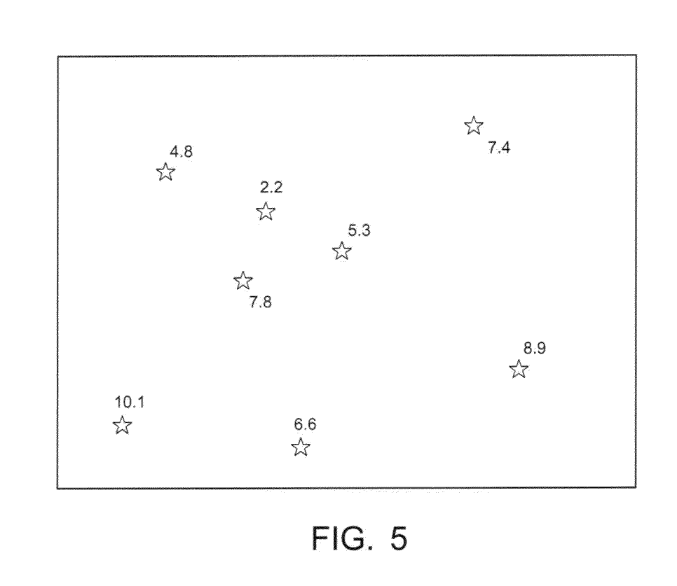

FIG. 5 illustrates a night sky image obtained by the apparatus disclosed herein at a 10 ms exposure time. The superimposed magnitudes of the stars illustrate that a magnitude 10 star is visible through the electro-optical assembly.

The apparatus and method described above may be used for estimating both attitude and angular rate of a spacecraft, or, alternatively, the apparatus and method may be used for estimating attitude only or only the star centroids. In the application wherein only the star centroids are required, the output of the centroiding 45 can be directly sent to the memory 53 for output to spacecraft. In another application wherein only attitude is estimated, the attitude estimate form block 48 can be directly sent to the memory 53. In this case the recursive identification 51, MEMS motion sensing device controller 43, EKF 50 and star position prediction 52 may not be required.

Although the present invention has been described with respect to specific details, it is not intended that such details should be regarded as limitations on the scope of the invention, except to the extent that they are included in the accompanying claims.

We claim:

1. A system for estimating attitude of a spacecraft, comprising:
an optical lens system for collecting light from stars and focusing it on a controllable light amplification device, the light-amplification device having a first modulation transfer function;
an image coupling device;
an image sensor having a second modulation transfer function; and
a computer memory and processor programmed to detect stars, compute star centroids and estimate attitude of the spacecraft from an output of the image sensor.

2. The system of claim 1 wherein the first modulation transfer function is higher than the second modulation transfer function.

3. The system of claim 1 wherein the image coupler device is a fiber optic taper bundle.

4. The system of claim 1 wherein the image sensor is a CMOS sensor array having a full-frame readout speed of at least 1 frame per second.

5. The system of claim 1 wherein the image sensor is a CCD sensor array having a full-frame readout speed of at least 1 frame per second.

6. The system of claim 1 wherein the image sensor is an EMCCD sensor array having a full-frame readout speed of at least 1 frame per second.

7. A system for estimating attitude and angular rates of a spacecraft, comprising:
an optical lens system for collecting light from stars and focusing it on a controllable light amplification device, the light-amplification device having a first modulation transfer function;
an image coupling device;
an image sensor having a second modulation transfer function; and
a computer memory and processor programmed to detect stars, compute star centroids, estimate attitude of the spacecraft from an output of the image sensor and estimate the angular rate of the spacecraft.

8. The system of claim 7 wherein the first modulation transfer function is higher than the second modulation transfer function.

9. The system of claim 7 wherein the angular rate estimation includes the recursive identification of stars and predictions of star positions.

10. The system of claim 7 further comprising a MEMS motion sensing device for providing rates to the computer processor and memory when light from stars is not available.

11. The system of claim 7 wherein the image coupler device is a fiber optic taper bundle.

12. The system of claim 7 wherein the image sensor is a CMOS sensor array having a full-frame readout speed of at least 1 frame per second.

13. The system of claim 7 wherein the image sensor is a CCD sensor array having a full-frame readout speed of at least 1 frame per second.

14. The system of claim 7 wherein the image sensor is an EMCCD sensor array having a full-frame readout speed of at least 1 frame per second.

15. A method for estimating attitude of a spacecraft, comprising:
receiving star light through an optical system;
amplifying the star light with a light amplification device, the device being controlled by an intensifier controller, to produce images of stars at a selected exposure time and image frequency; and
processing the images of stars by centroiding to determine line-of-sight vectors, correcting aberrations, using stored data to identify stars, predicting star fields around the identified stars and using the predicted star fields to control acquisition of the image and using the identified stars to estimate attitude.

16. A method for estimating attitude and angular rate of a spacecraft, comprising:
receiving star light through an optical system;
amplifying the star light with a light amplification device, the device being controllable, to produce images of stars at a selected exposure time and image frequency; and
processing the images of stars by centroiding to determine line-of-sight vectors, correcting aberrations, using stored data to identify stars, using the identified stars to estimate attitude; and
using body vector data and filtering the body vector data at the selected image frequency to predict the angular rate of the spacecraft.

17. The method of claim 16 further comprising providing data from a MEMS motion sensing device before filtering the body vector data.

18. A system for estimating centroids of stars, comprising:
an optical lens system for collecting light from stars and focusing it on a controllable light amplification device, the light-amplification device having a first modulation transfer function;
an image coupling device;
an image sensor having a second modulation transfer function; and
a computer memory and processor programmed to detect stars and compute star centroids.

19. A method for estimating centroids of stars, comprising:
receiving star light through an optical system;
amplifying the star light with a light amplification device, the device being controllable, to produce images of stars at a selected exposure time and image frequency; and
processing the images of stars by centroiding.
